(19) United States
(12) Patent Application Publication
(10) Pub. No.: US 2003/0172356 A1
(43) Pub. Date: Sep. 11, 2003

(54) Centralized management of a distributed database system

(76) Inventors: Esa Pulkkinen, Tampere (FI); Juha Herajarvi, Lempaala (FI)

Correspondence Address: SQUIRE, SANDERS & DEMPSEY L.L.P., 14TH FLOOR, 8000 TOWERS CRESCENT, TYSONS CORNER, VA, 22182, US

(21) Appl. No.: 10/275,875

(22) PCT Filed: May 8, 2001
(86) PCT No.: PCT/FI01/00439

(30) Foreign Application Priority Data
May 10, 2000 (FI) 20001111

(51) Int. Cl. G06F 15/00

(52) U.S. Cl. 715/526

(57) ABSTRACT

The invention relates to centralized management of a distributed database system though an object-oriented interface. A gateway (23) is provided between the distributed database system (27, 28, 29) and the clients (21, 22) managing the objects in the system, such as the service management clients in the intelligent network (IN). The gateway (23) knows how the objects have been distributed to different databases within the database system. Responsive to an object request from a client (23), the gateway determines the correct database (27, 28, 29) that can be used to access the desired object(s). The gateway (23) uses database distribution techniques as the source of the object location information. An example of data distribution techniques is the use of a distributed view to different databases using database links. This allows the gateway (23) to be configured using information about entire management systems instead of individual objects, while providing mechanisms to look up individual objects stored in the databases of those systems.

### FIELD OF THE INVENTION

The invention relates to centralized management of a distributed database system though an object-oriented interface, and especially to centralized management of multiple service management points (SMP) in an intelligent network (IN).

### BACKGROUND OF THE INVENTION

The intelligent network (IN) technology provides solutions for telephone network operators to offer advanced services to the users of a telephone network. An example of an IN service is the virtual private network (VPN) service which offers a private telephone numbering scheme that allows a group of telephone subscribers to use shorter telephone numbers for calls to other subscribers in the group. The intelligent network technology focuses on implementing and maintaining such services used in the telephone network. Network operators can distinguish themselves from their competitors by offering advanced IN services to their customers.

The Intelligent Network consists of network elements of the IN system that communicate with network elements of the telephone network to provide services to the end-users of the network. An overview of the architecture is illustrated in FIG. 1. In this example all IN services are implemented by a single service logic program (SLP) whose instances run in a Service Control Point (SCP) machine, which interprets and acts on requests for service from a Mobile Switching Centre (MSC). The part of the MSC functionality that can trigger IN services is called a Service Switching Point (SSP). The SCP retrieves information about active IN services from an in-memory service database, where information about existing subscribers, their provisioned IN services and related management data is stored. A duplicate of the in-memory service database is maintained in a hierarchical database on the SCP machine, which is also propagated to the relational database in a Service Management Point (SMP) machine. Similarly, changes to the SMP database are propagated back to the SCP hierarchical database. An SMP can host one or more SCPs that are taken in use when the existing SCP capacity appears to be insufficient. The SMP database is used by different management applications, usually through an SMI (Service Management Interface). The SMI provides a high-level CORBA application programming interface (API) to the data stored in the SMP database, and allows the operator to assign, parameterise and configure new commercial IN services to the subscribers. CORBA (Common Object Request Broker Architecture) is a distributed architecture framework specified by the Object Management Group (OMG).

The IN platform also allows the IN operator to create, manipulate and configure new commercial services to the network using a Service Creation Environment (SCE). A Service Management Access Point (SMAP) is a network element that handles outside access to the IN system. Interfaces for specific use of IN services through an interactive selection facility are provided through an Interactive Voice Response (IVR) platform in the SMAP, which communicates with the SMI to allow a subscriber to modify his personal service, e.g. to recharge his credit from a voucher. The web clients (e.g. service providers or subscribers) may also have access to the SMI and SMP via the Internet or an intranet (possibly though the SMAP).

The SMP machine hosts the database containing the management data, and this information is propagated to the SCP database. The Service Management Interface (SMI) is a distributed application-programming interface the primary purpose of which is to provide the client developer with mechanisms for provisioning and management of intelligent network services and subscriptions stored in a database in the Service Management Point (SMP), i.e. to store, retrieve and modify IN service and subscription data in the relational database of the SMP.

The primary requirements for the SMI servers are improved scalability and performance, since those have a direct effect on the number of subscribers that can be handled. The SMI servers are used in an online transaction processing (OLTP) environment where several client applications request services from the SMI. The number of users of these services is expected to rise in the same proportion as the number of subscribers that use IN services. Each subscriber in the system needs to be provisioned and managed through the SMI. Several applications, some of which are even invoked from services in the telephone network, query information about subscribers and their services through the SMI. Therefore, it can be expected that the number of instances of client applications will rise steadily.

Any limits to the scalability of the system should be eliminated to ensure that the system can be extended to respond to the increase in the number of users. This means that it should be possible to use the system in a distributed environment, where the same services are provided by several physical servers. In the end, it also means that the number of platforms that need to be managed will rise. A single platform can manage only a limited number of service requests per second, which limits the number of subscribers that can be managed through one platform. This can be improved by purchasing more efficient hardware, and this has been used to gain substantial improvements. Nevertheless, the number of subscribers that need to be managed rises more rapidly than improvements in new hardware can be taken in use. In addition, since the use of new types of hardware and software requires extensive testing, offering those for use is a long process. Often the hardware is already obsolete by the time it can be fully tested and deployed to the customer. In short, improvements in the hardware or the third-party software cannot be relied on to offer sufficient increase in scalability.

It should be possible to use several SMP machines and configurations to allow the SMP load to be divided between several platforms. In those cases, either the databases are separate, or data is replicated between them. If the data is stored in multiple separate databases, it does not need any synchronization, instead, some approach should be used to ensure that information about particular objects is always stored in the correct databases. On the other hand, using replication between SMP databases means that all changes between the databases need to be propagated constantly, which may degrade the performance of the system.

The management of multiple SMP platforms is an important prerequisite for enabling the system to scale up by increasing the number of SMPs in the operator's network. The management of these SMP platforms should be organised in a way that eliminates unnecessary or manual work for keeping track of the information stored in separate platforms. This suggests that the approach selected should allow centralised management of multiple SMP platforms while allowing management operations to be done from any terminal connected to the network.

The growing use of the SMI implies new requirements related to scalability that have not been addressed in the existing solutions to the extent desired. In particular, the SMI is expected to provide reasonable performance to a large number of simultaneous users, while allowing convenient access to all IN management information for client applications using the SMI. Similarly, when new network elements are added to the system to improve performance, the system should be able to take advantage of the increased performance without compromising the convenience of a single management interface.

Generally, similar problems can be also found in any distributed database system using object-oriented interfaces for managing the data.

### DISCLOSURE OF THE INVENTION

An object of the present invention is to enable centralized management of a distributed database system though an object-oriented interface.

This is achieved by a method, a gateway unit and an intelligent network disclosed in claims 1, 6 and 11, respectively.

In the present invention a gateway is provided between the distributed database system and the clients managing the objects in the system, such as the service management clients (the SMI clients) in the intelligent network (IN). The gateway knows how the objects have been distributed to different databases within the database system. Responsive to an object request from a client, the gateway determines the correct database that can be used to access the desired object(s). The gateway uses database distribution techniques as the source of the object location information. An example of data distribution techniques is the use of a distributed view to different databases using database links. This allows the gateway to be configured using information about entire management systems instead of individual objects, while providing mechanisms to look up individual objects stored in the databases of those systems.

An ordinary CORBA name service implementation would require the registration of individual objects stored in the database specifically to the name service, since CORBA name service implementations do not have knowledge about location and structure of the database used by the management system.

### BRIEF DESCRIPTION OF THE DRAWINGS

In the following the invention will be described in greater detail by means of preferred embodiments and with reference to the accompanying drawings, in which

FIG. 1 shows an overview of an intelligent network, and

FIG. 2 illustrates the gateway architecture according to the invention.

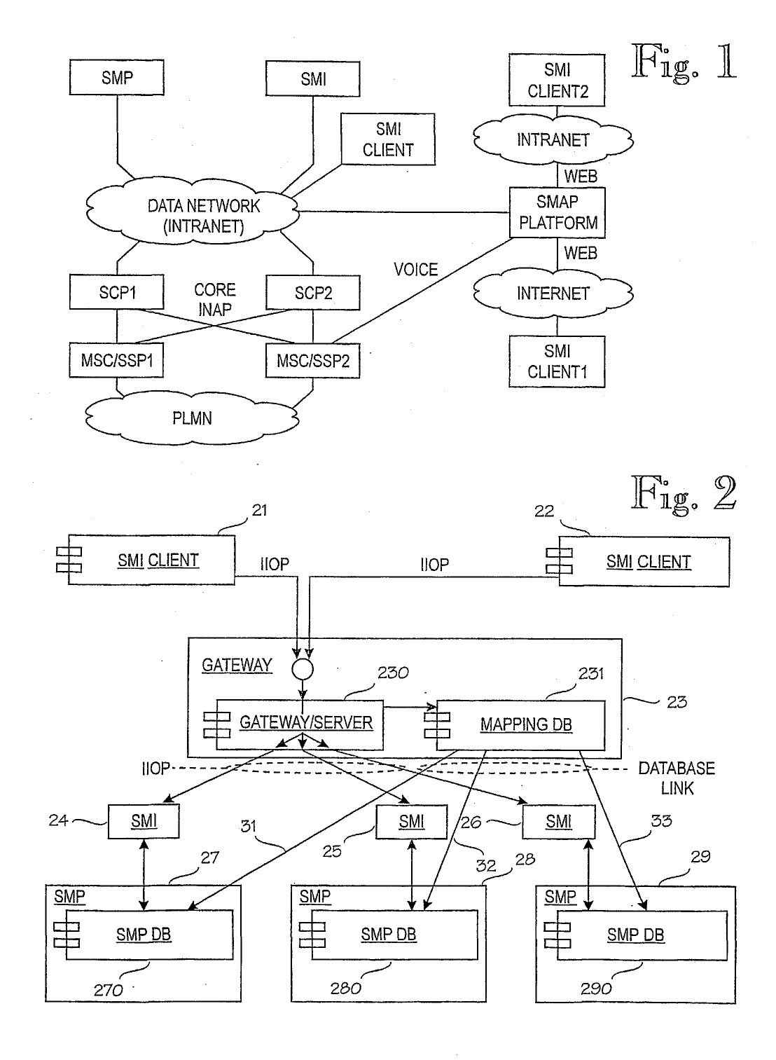

### PREFERRED EMBODIMENTS OF THE INVENTION

The preferred embodiments of the invention are in the following described as implemented in an intelligent network (IN) for managing multiple SMPs (service management points) through the SMI interface. The invention is, however, applicable to an object-oriented centralized management interface of any distributed database system.

The service management functionality of the IN system is based on a client-server architecture with several kinds of interacting servers and clients. Each server machine contains software, which provides the application logic of the server. Conceptually, the primary objects of interest represented in the IN system are the subscribers of the IN services, who are normal telephone users for whom the network operator has enabled the use of IN services. A subscriber may subscribe to commercial IN services, each of which provides some functionality for the telephone of the subscriber. For example, one commercial service associated with a subscriber may cause telephone calls to be forwarded to another telephone, if the call is made after working hours. Commercial services are composed of blocks of functionality called functional definition elements (FDE) that can be combined to produce complex services. A commercial service describes the structure of a subscription when it is provisioned to a subscriber. It is necessary to provision a subscription to a subscriber before that subscriber can use the commercial service. When a service is defined, it is possible to leave some aspects of the service undefined, and those aspects must be specified later during provision, allowing some flexibility in customising the service to the purposes of each subscriber. Each FDE introduces some parameters that must be specified either in the service definition, in subscriber or group parameters, or in the subscription, determined by the definition of the FDE in the commercial service. It is also possible to arrange subscribers into groups, and both the subscribers and the groups may imply some parameters to the services for subscribers belonging to those groups. A typical example of an entity that would be represented as a group in the IN solution would be a company that buys an IN service for all of its employees to use. The system also supports the notion of service providers. Different commercial services, subscribers, groups, lists and other objects manipulated in the system are managed by service providers. Each service provider is conceptually a separate entity that is not interested in what other service providers do. To manage service providers and the network used for executing the services, there is a concept of a network operator, which represents the highest form of authority in the network.

The SMP machine hosts the database containing the management data, e.g. the commercial services described above. The SMP database is an object-oriented (relational) database. The data in the database is arranged into data objects. For example, commercial service data of a subscriber may establish a domain object which is created by the service provider when the subscription to the service is provisioned to the subscriber. Other individual domain objects may include subscribers, groups, lists, etc.

The Management Interface (SMI) used as an example herein is developed by Nokia Networks Inc, but similar object-oriented interfaces for managing the SMP databases may be available also from other IN system manufactures. The SMI implements a set of services, each represented by distributed CORBA interfaces defined in the interface definition language (IDL) by the OMG. There are roughly three categories of interfaces in the SMI: factory interfaces provide access and return objects that implement other interfaces; domain object interfaces provide the core functionality of the SMI platform, such as subscribers, commercial services, subscriptions and providers; implementation control interfaces provide access to control some implementation-related parameters and functionality, such as transactions, access control, assignment of objects to SCPs and maintaining connections between the client and the SMI servers. The domain object interfaces can further be split into two categories of interfaces. One category defines the basic domain objects related to how the IN services are provisioned to a subscriber, and for storing that information in the database. The rest of the domain object interfaces consist of mechanisms that allow introspection of the structure of the commercial service. The factory interfaces of the SMI provide access to the domain objects. For almost every type of domain object interface, a corresponding factory interface can be used to create and load the domain objects. For example, to access commercial services stored in the SMP database, the client needs to obtain an instance of the idICommercialServiceFactory interface, with which it can retrieve objects representing commercial services that implement the idICommercialService interface. Several methods of access are provided, such as listing all commercial services and finding a specific commercial service by name or by an identification number. Similar operations are provided by other factories, depending on what operations make sense for each type of domain object.

To use the SMI servers, client applications need to log on to the SMI servers and provide identification information about the person using the system. This information is used by basic security and access control subsystems to restrict the types of operations that are allowed for that user. The server maintains sessions that are used for various purposes, such as maintaining transactional consistency. The client initially obtains a reference to an idISessionManager interface, through which it is possible to create new sessions to the SMI servers. For each session, the client needs to obtain sufficient access to the operations of the SMI using the idIAccessManager interface. With the necessary access rights, the client can then use all the operations of the SMI implied by the level of access obtained. The term client refers to any party which has the right to access the management data, typically service providers and the subscriber.

According to the present invention, in a multiple SMP environment, a basic architectural model to solve the scalability problem is a gateway, which determines which servers should be used when a client connects to the SMI servers. Different variations of this idea are described in the following sections.

A schematic description of the gateway architecture in accordance with the preferred embodiment of the invention is illustrated in FIG. 2. SMI clients 21 and 22 are connected to a gateway 23 by an Internet Inter-ORB Protocol (IIOP) specified by the object management group (OMG) for CORBA. IIOP is a standardised protocol for communicating between distributed applications in TCP/IP (Transport Control Protocol/internet Protocol) based networks, such as the Internet. The clients 21 and 22 may support the existing SMI interfaces to connect to the gateway 23, or a new interface specific to the gateway can be used. The advantage of using the SMI interface is that existing clients can be supported even with the gateway. Some new interfaces are necessary anyway to allow fine-grained control of the location of objects when they are created in one of the SMPs.

The gateway 23 is further connected to SMI servers 24, 25 and 26 by respective IIOP interfaces. The SMI servers 24, 25 and 26 are further connected to SMPs 27, 28 and 29, respectively. The SMPs 27, 28 and 29 contain relational SMP databases 270, 280 and 290, respectively, which constitute the distributed database system to be managed in a centralized manner from the gateway 23.

The gateway 23 contains a gateway server 230 and a mapping database 231. The clients 21 and 22 make the connections and send object requests to the gateway server 230. The gateway server 230 selects the SMI server 24, 25 or 26 with which the client should communicate on the basis of the mapping database which contains a mapping between object identifiers and an associated SMP identification.

It is important to ensure that the mapping database 231 is efficient, and that it requires minimal maintenance. It is likely that the mapping database 231 will be added to the system after a period of use, so the structure should accommodate changes in the physical configuration of the SMPs in use. It is also expected that new SMPs will need to be added after the gateway server has been taken in use. Therefore, the database structure should be easily configurable for new situations.

Each SMP database 270, 280 and 290 includes an object table, sms_sh.sh_s_object, containing reference information about most objects in the respective SMP platform. It can be any table that is retrieved from the SMP. A mapping table in the database 231 can be constructed from the contents of the object tables from different SMPs, assuming that there is a unique way to identify objects from different SMPs. The object identifier field objected of the object table is not sufficient for this purpose, as different SMPs may have been independently constructed and contain overlapping object identification numbers. An approach for building the mapping table in the database 231 would be to include a special identification field SMPid in the database view that identifies the SMP. An SQL statement for building the database view for a case where there is only two SMPs in the system can be:

This SQL statement retrieves object identifiers, object references, and object names from the object tables sms_sh.sh_s_object in the SMP1 and SMP2, and creates a mapping table in which each piece of the retrieved object information is associated with (mapped to) the identifier SMPId of the SMP it is retrieved from. This database view is made over database links 31, 32 and 33. In order to facilitate the addition of new SMPs to the system, the mapping database 231 could alternatively have separate views for each SMP's information. The server 230 reading the mapping tables would need to query each view separately to find out which SMP contained the requested object. Thus, the gateway 23 uses a database distribution technique which is based on database links or distributed relation views as the source of the object location information. Other database distribution techniques can also be employed. The view creation depends on the number of SMPs already installed to the system. There is a range of mechanisms in the database to enhance the performance of this view, ranging from read-only snapshots to full replication. It is also possible to configure an Oracle database to take advantage of parallel queries in conjunction with views using this structure to improve the performance of the queries from the mapping database. The advantage of the use of database distribution techniques is that it is not necessary to update information about changes to objects in the SMP databases in the mapping database, but instead, the information in the mapping database will automatically remain up to date with the SMP databases.

Examples of other database distribution techniques:

1. Distributed queries. Distributed queries are normal SQL queries where the table name also includes information about the location of the actual database where the query is to be executed. For example, in Oracle,

SELECT * from sms_sh.sh_s_object@SMP_{—}1;

is a distributed query referring to the sms_sh.sh_s_object table in the database SMP_{—}1. If SMP_{—}1 is located in another machine, that query, when executed, communicates through the network to find the correct database.

2. Read-only snapshots. A read-only snapshot is defined by a distributed query that references one or more master tables, views or other snapshots. A read-only snapshot is defined in Oracle by an SQL clause using a distributed query such as:

CREATE SNAPSHOT smp_{—}1_objects AS

SELECT * from sms_sh.sh_s_object@SMP_{—}1;

This defines a snapshot of the sms_sh.sh_s_object table from the database named SMP_{—}1. The snapshot can be queried using normal SQL statements just like any normal table. The snapshot can only be read from, and can not be updated, and reflects the data in the master table. There are various options for the CREATE SNAPSHOT command to configure the performance and other characteristics of the snapshot.

The difference between snapshots and distributed queries is that the application that uses the distributed query does not need to know about the actual location of the queried table. The data is periodically updated from the master table. The difference to distributed queries is that access to a snapshot is usually faster, since the database can maintain a local copy of the data instead of always going through the network for the queries.

3. Multi-master replication. A multi-master replication is like a snapshot, except that you can update data from all databases and the data is synchronised between the databases by using propagation (e.g. periodic updates of modifications between databases), and none of the master sites have the constraints of read-only snapshots. From the point of view of the user of the database, this otherwise looks like a read-only snapshot, except that you can write to the replicated table through multiple masters.

The mapping database 231 may also include other configuration information about the SMPs in the system, to be used by the gateway server 230 in the selection of the approriate SMP or SMI server. For example, the gateway server 230 may need a list of all SMPs installed in the system as well as the associated SMI servers. A natural place to store this information is the same database 231 that stores the mapping view.

In the preferred embodiment of the invention, an object request sent by the SMI client 21 or 22 contains an object identifier, an object reference and/or an object name of the requested object. The gateway server 230 makes an object location enquiry in the mapping database 231. As explained above, the object identifiers, the object references and the object names are mapped to the SMP identifiers in the mapping database, and therefore an enquiry which uses one or more of these parameters as key words will give one or more SMPs in which the object(s) matching the parameters can be found. However, it should be appreciated that the above parameters are given only as examples, and that any object information can be used in the mapping database 231 and the object request for identifying the object.

Upon receiving the SMP identifier(s) from the database 231, the gateway server 230 will determine on the basis of the configuration data which one of the SMI servers 24 to 26 can access the SMP indicated by the SMPId. Then the gateway server 230 establishes a connection and forwards the object request to the selected SMI server. The selected SMI server 24 to 26 then processes the request normally and returns the results to the gateway server 230, which sends the results to the client application 21 or 22. After that, the requests sent by the client that depend on the result of the query are communicated directly to the selected SMI server. If the gateway 23 must be able to influence the further communication between the SMI server and the client, the gateway server may encapsulate the results in a proxy object that is sent to the client application 21 or 22 instead of the original object received from the SMI server. In this case, all subsequent communication using the result of the request is carried out via the proxy.

It should appreciated that the above operation of the gateway server 230 after obtaining the SMPId is only an illustrating example, and the obtained location information can be utilized in various ways in order to provide the requested object to the client without departing from the basic invention. For example, upon having established the connection to the selected SMI server, the gateway server 230 may send an object reference (an object factory reference) which represents the SMI server connection, e.g. a factory object in the SMI server. The gateway server 230 may alternatively also send an object reference which points to the requested object in the SMI server. After that, the client communicates with the selected SMI server. The client need not be aware that there are separate SMI servers. Alternatively, the gateway server 230 may send an address of the selected SMI server or other location information to the client, and the client establishes the connection to the selected SMI on the basis of this address or location information. In each case the client can efficiently communicate with the SMI server after the specific SMI server that needs to handle the operations is unambiguously determined by means of the mapping database 231.

There are also various methods and criteria which could be used for the selection of an SMI server. In principle, there could be several SMI servers connected to the same database. The gateway 23 could choose any of the servers that have access to the same physical database. For requests from the same client, only one server should be used for objects residing in the same SMP database. This is because CORBA servers do not always allow clients to pass objects returned by other servers, such accesses are unnecessarily inefficient, or mixing objects from separate servers interferes with implementation-related mechanisms, such as explicit transaction support.

The gateway architecture according to the invention decouples the SMI servers from the new multiple SMP architecture so that no changes to the SMI servers are needed. It also localises the decisions related to supporting multiple SMPs in one place so that the implementation could be independently enhanced. It is still possible to use the existing mechanisms to connect to any SMI servers in the system or to take advantage of the gateway for improved access to the whole system. This would be a decision made in the client; existing clients would use the less sophisticated mechanism, but they would be able to operate just like before.

Further, an alternative embodiment of the invention uses a CORBA name server in addition to or as part of the gateway server, and the gateway server implements portions of the name service interface that are integrated as part of the name service hierarchy, still using the database distribution techniques as a source of information for resolving queries for objects. The name service can be integrated with the invention by implementing the CORBA::NamingContext part of the standard CORBA name service interface in the gateway.

The application has above been described by means of the preferred embodiments to illustrate the principles of the invention. Regarding the details the invention may vary within the scope and spirit of the accompanying claims.

1. A method of providing an object-oriented interface to a distributed database system having two or more databases (27,28,29), the method comprising
a gateway (23) uses a database distribution technique as a source of information indicating the location of at least one object,
a client (21,22) sends an object request to the gateway (23),
a gateway server (230) utilizes said location information for providing the client with access to the requested object.

2. A method as claimed in claim 1, wherein the gateway (23) performs one or more of the following alternative functions in response to said object request: the gateway (23) sends to the client (21,22) the location information of the requested object, the gateway sends to the client (21,22) a reference to the requested object in a database interface server which provides access to said requested object in said location, the gateway (23) sends to the client (21,22) a reference to a database interface server which provides access to said requested object in said location, said reference being derived on the basis of said location information, and/or the gateway (23) forwards the object request to said database interface server.

3. A method as claimed in claim 1 or 2, wherein said database distribution technique is used to retrieve or replicate at least part of the object information stored in said at least two databases (27,28,29) to the gateway (23), and the gateway (23) associates each retrieved or replicated piece of said object information with one of said at least two databases.

4. A method as claimed in claim 3, wherein said object information contains one or more of the following data items: an object type, an object name, and an object identifier.

5. A method as claimed in claim 1, 2, 3 or 4, wherein said database distribution technique comprises database links or mapping views from the gateway (23) to the databases (27,28,29).

6. A gateway unit providing an object-oriented interface to a distributed database system, said gateway unit (23) comprising
a mapping database (231) which uses database distribution techniques as a source of information indicating the location of at least one object,
a gateway server (230) which is responsive to an object request sent by a client (21,22) for making a location enquiry to said mapping database (231) in order to obtain location information of the requested object,
the gateway server (230) being arranged to utilize said location information for providing the client with access to the requested object.

7. A gateway as claimed in claim 6, wherein the gateway server (230) is arranged to perform one or more of the following alternative functions in response to said object request: the gateway sends to the client (21,22) the location information of the requested object, the gateway sends to the client (21,22) a reference to the requested object in a database interface server which provides access to said requested object in said location, the gateway sends to the client a reference to a database interface server (24,25,26) which provides access to said requested object in said location, said reference being derived on the basis of said location information, and/or the gateway forwards the object request to said database interface server (24,25,26).

8. A gateway as claimed in claim 6 or 7, wherein said database distribution technique is used to retrieve or replicate at least part of the object information stored in said at least two databases (27,28,29) to the mapping database (231), and the mapping database (231) associates each retrieved or replicated piece of said object information with one of said at least two databases.

9. A gateway as claimed in claim 8, wherein said object information contains one or more of the following data items: an object type, an object name, and an object identifier.

10. A gateway as claimed in claim 6, 7, 8 or 9, wherein said database distribution technique comprises database links or mapping views from the gateway to the databases (27,28,29).

11. A communications system comprising
at least two databases (27,28,29),
database interface servers (24,25,26), each server having access to one of the databases,
at least one interface client (21,22),
a gateway (23) having a mapping database (231) which uses database distribution techniques as a source of information indicating the location of at least one object, and a gateway server (230) which is responsive to an object request sent by the client (21,22) for making a location enquiry to said mapping database (231) in order to obtain location information for the requested object,
the gateway server (230) being arranged to utilize said location information for providing the client with access to the requested object.

12. A communications system as claimed in claim 11, wherein the gateway server (230) is arranged to perform one or more of the following alternative functions in response to said object request: the gateway (23) sends to the client (21,22) the location information of the requested object, the gateway sends to the client (21,22) a reference to the requested object in a database interface server which provides access to said requested object in said location, the gateway (23) sends to the client a reference to one of the database interface servers (24,25,26) which provide access to said requested object in the database indicated by said location information, and/or the gateway (23) forwards the object request to said database interface server (24,25,26).

13. A communications system as claimed in claim 11 or 12, wherein said communications system is an intelligent network (IN), said object-oriented databases are service management point (SMP) databases located in at least two location management points (SMP), said database interface servers (24,25,26) are management interface servers, and said interface client is a management interface client.

14. A system as claimed in claim 13, wherein said database distribution technique is used to retrieve or replicate at least part of the object information stored in said SMP databases to the mapping database, and the mapping database associates each retrieved or replicated piece of said object information with one of said SMP databases.

15. A system as claimed in claim 14, wherein said object information contains one or more of the following data items: an object type, an object name, and an object identifier.

16. A system as claimed in any one of claims 11 to 15, wherein said database distribution technique comprises database links or mapping views from the mapping database to the SMP databases.
